(19) United States
(12) Patent Application Publication
(10) Pub. No.: US 2025/0358519 A1
(43) Pub. Date: Nov. 20, 2025

(54) Automatic Camera Zoom for AR Glasses

(71) Applicants: Shijun Sun, Redmond, WA (US); Daniel Sun, Redmond, WA (US)

(72) Inventors: Shijun Sun, Redmond, WA (US); Daniel Sun, Redmond, WA (US)

(21) Appl. No.: 18/668,485

(22) Filed: May 20, 2024

(51) Int. Cl. H04N 23/69; G01S 15/04; G10L 15/08; G10L 15/22; H04N 23/62

(52) U.S. Cl. CPC H04N 23/69; H04N 23/62; G01S 15/04; G10L 15/08; G10L 2015/088; G10L 15/22; G10L 2015/223

(57) ABSTRACT

Vision loss, a common challenge associated with aging, affects a significant portion of the global aging population. The proposed system introduces an automatic zooming solution as an enhancement to camera systems on AR glasses. When there is an object in front of the user within an arm's length, the camera will zoom in automatically to allow more details of the object to be captured. Technically, the proposed system leverages user voice commands for media captures to check the acoustic characteristics of the user environment. Specifically, echo signals will be used to determine whether there is any significant object in front of the user within a predetermined distance or distance range. The proposed solution can be enabled or disabled by a user explicitly. And, when it is enabled, the zoom-in decision logic runs in parallel to conventional voice assistance operations, therefore, does not introduce significant latency to default photo capture experience.

### BACKGROUND

With an aging population across the globe, it has become increasingly critical for the whole of society to empower elderly individuals to navigate the challenges of everyday life with confidence, independence, and dignity.

Gradual vision loss, e.g. due to age-related macular degeneration (AMD), is one of the typical physical challenges to the aging population. Within the US, approximately 12.6% of Americans aged 40 and older had AMD in 2019. The prevalence of AMD increased with age, ranging from 2% among people aged 40 to 44 to 46.6% among those aged ≥85.

While there is no permanent cure for most vision impairment, there have been various low vision rehabilitation services to assist patients in coping with changing vision. To contribute along the direction, we'd like to introduce an additional option based on the recent innovations in ML/AI technologies and AR glasses.

There are AR glasses on the market already to allow users to capture photos using their voice commands and then provide AI services to respond to user's questions based on the captured photos. For example, modern AI systems can recognize text content on a product package with reasonable accuracy and respond to user's questions accordingly. It's a great step towards helping people with vision impairment.

However, due to limited physical space on a glasses frame, as well as limited computation power and battery capacity of the current AR glasses, the camera systems on the frame are typically limited in pixel resolutions, and also optimized for wide viewing angles. Although it is possible for the camera system to capture broad views with a reasonable quality, as a tradeoff, it is typically not designed to capture finer details in the images, e.g. fine prints on a medicine package held by a user's hand.

As a comparison, recent smartphones allow complex computational photography leveraging wide angle lens, telephoto lens, primary lens, and even depth sensor, in integrated camera systems. Additionally, to capture fine details, users can manually zoom in or simply put the phone camera as close as possible to the specific image objects. It's not an expected experience however for AR glasses users, who would look at an object in a natural viewing distance, rather than placing their face only a few centimeters from the object.

The goal of the proposed solution in this document is to allow automatic zooming of the AR glasses camera. It will be largely based on the existing AR glasses hardware system, including the respect of limitations on camera pixel resolution and existing user experience flow, etc. To be specific, when a significant object is within a short distance from the user's face, the camera system will automatically zoom in optically to allow more details of the object to be captured in order to achieve a visual quality equivalent to 20/20 vision or better.

A major step in the proposed system is to detect whether any significant object or obstacle is in front of the user, and within a certain distance.

There are various ways to measure distance of various target objects, tailored to different applications. For example, radio-based distance detection, often associated with RADAR (Radio Detection and Ranging), is a technology that uses radio waves to determine the distance, angle, or velocity of objects; LiDAR (Light Detection and Ranging) is a similar technology that uses light waves from a laser instead of radio waves; and, Sonar (Sound Navigation and Ranging) is a technique that uses sound waves to determine the distance to an object. In general, all the techniques rely on time-of-flight (ToF) to measure a distance based on speed of light or sound waves in the media.

As far as we know, there is no AR glasses with built-in RADAR or LiDAR yet on the market. Although it is technically plausible, it might not be practical given the limited physical space on the front side of an AR glasses frame.

Active Sonar is a recommended option in our proposed system. For privacy reasons, all speakers on AR glasses are internal or user facing, e.g. through bone conduction mechanism. It's technically possible to introduce an external facing speaker to allow a sound impulse signal explicitly for Active Sonar, however, again there might be limitations in physical space on the frame. As a major part of this proposed system, we'd like to leverage the user voice as the source of the audio signals for the Active Sonar system, i.e. with the user as an essential part of the system.

Both DSP and Deep Learning algorithms have been developed in the past for acoustic echo analysis. We do not plan to present implementation details of any algorithm in this document. However, we believe this is a topic not explored yet by others in the technical community. We'd also like to call out that the echo analysis algorithms should be general enough to cover typical materials in our daily life, i.e. with a wide range of sound absorption coefficients.

### SUMMARY

The proposed system provides an automatic zooming solution for cameras on AR glasses. Specifically, when there is an object in front of the user within an arm's length, the camera will zoom in automatically to allow more details of the object to be captured.

The system leverages user voice commands for media captures to check the acoustic characteristics of the user environment through echo signals. When it's determined there is a significant object in front of the user within a predetermined distance or distance range, the system will initiate the camera with a predetermined zoom-in option.

A preferred zoom-in factor is 2×, i.e. relative to the default camera setting for the AR glasses. Additionally, the zoom-in is preferably optical zoom rather than digital zoom.

The user voice commands include the wake words that are used to trigger typical voice assistance systems, e.g. “hey google”, “alexa”, or “hey babblefish”, etc. for various product brands.

### BRIEF DESCRIPTION OF DRAWINGS

FIG. 1. High level illustration of the data flow for the proposed system.

FIG. 2. High level illustration of the user experience based on the proposed system.

FIG. 3. High level illustration of a hypothetical bone-conduction headphone with a camera.

### DETAILED DESCRIPTIONS

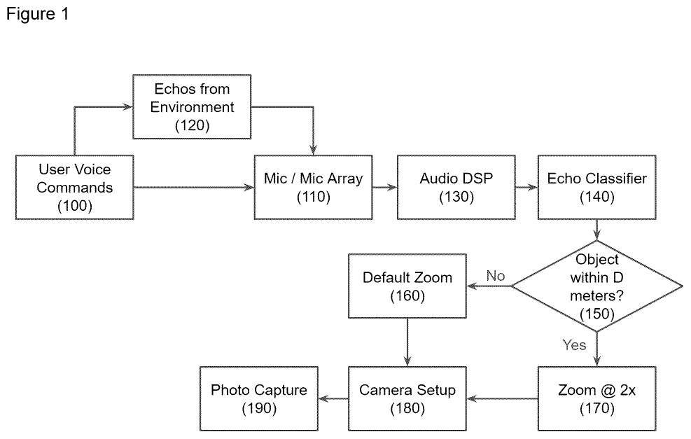

FIG. 1 provides an illustration of the data flow for the proposed system. First, the system is triggered by a user voice command (100) to capture a photo. The microphone or mic array (110) of the AR glasses captures the user voice signals as well as the echo signals (120) from the user environment. The captured audio signals are then put through a DSP module (130) to process the data in both time and frequency domains across all channels in case a mic array is available in the system. The results are provided to an echo classifier (140) to determine whether there is any object in front of the user within a relatively short distance. When an object is detected within D meters (150), the camera zoom option is set to 2× relative to the system default (170) or another predetermined option. Otherwise, the camera zoom settings stay as the system default (160). Once the AR glasses confirms that the user voice command is indeed to capture a photo, the zoom settings are applied during the camera system setup or initiation step (180), and then a photo can be captured (190) by the AR glasses accordingly.

As an example, the D parameter in the zoom decision logic (150) can be 0.5 or 0.25 meters. For an object 0.5 meters away, and the speed of sound as ˜340 meters per second, the time-of-flight (ToF) for the round trip of the voice signals is 2.94 milliseconds, i.e. from the user to the object and then come back to the AR glasses as echos. Similarly, for an object 0.25 meters away, the ToF is 1.47 milliseconds. For modern mic and mic arrays operating at 44.1 k or 48 k sampling rate, the ToF in the order of several milliseconds should be detectable.

The echo analysis and zoom decision operation are completely in parallel to typical voice assistance operations where the AR glasses determine whether the user's intention is to capture a photo or not. Technically, it will not add any significant latency to the overall photo capture experience.

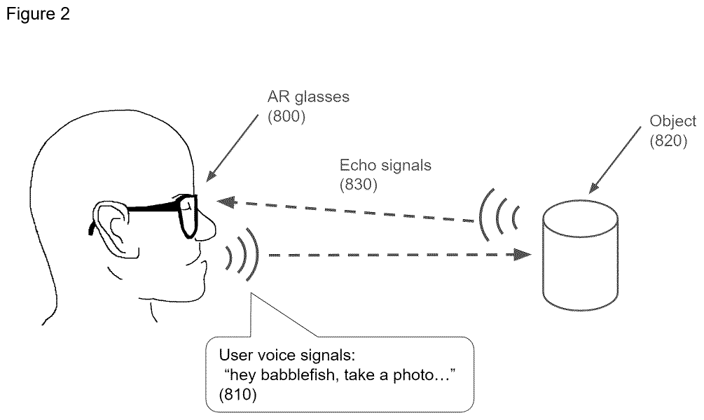

FIG. 2 provides a high-level illustration of the user experience based on the proposed system. As an example, the user voice command (810) can be “hey babblefish, take a photo . . . ”. The phrase “hey babblefish” is a hypothetical wake word for the AR glasses. Once the voice signals reach the object (820), the signals will be partially bounced back as echo signals (830). The voice signals and the echo signals will both be captured by the mic or mic array on the AR glasses (800).

From a user experience perspective, the user utters a voice command, and then the AR glasses captures a photo. There is no explicit difference in the actual user flow when the system handles the automatic zoom logic internally.

To allow full control by the users on the system internal logics, device settings can be provided to users through device setup apps, for example, on mobile phones. Users can decide whether to enable the automatic zooming logic. Similarly, it is possible for application-level integration with the device settings to enable or disable the zooming logic based on the specific user experience.

The proposed system can be applied to other wearable devices in addition to AR glasses. Any device with a camera, a mic or mic array, and AI-based or user-voice-driven capture experience can technically leverage the proposed system.

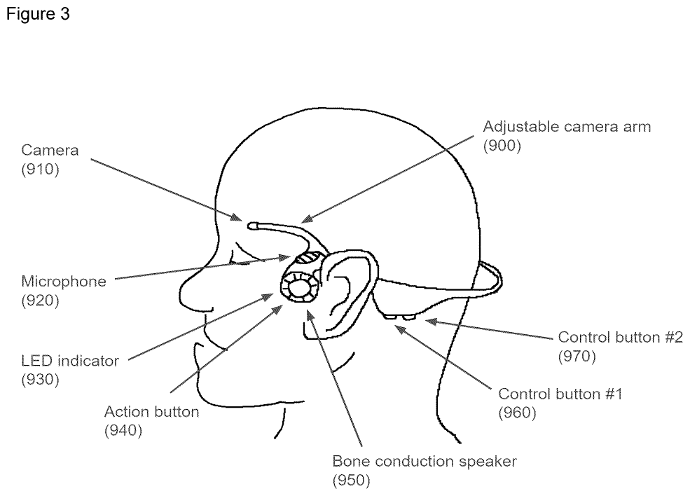

As an example, FIG. 3 shows a left-ear view of a hypothetical head-wearing device with a camera. The device has a camera (910) with a flexible camera arm (900) to adjust the camera angle. The device also has a microphone (920), an LED indicator for recording (930), which is collocated with an action button (940) and a bone-conduction speaker (950). The action button (940), the control button #1 (960), and the control button #2 (970) can be used to control the camera, e.g. to manually zoom in/out using the control buttons and capture photos using the action button, in addition to using voice commands.

Note: The focus of the writing is on the basic concept. There are many possible implementation level optimizations and more advanced ML algorithms for the echo analysis and classification, which could vary for different devices, hence will not be included at this moment.

1. An automatic camera zooming system for a head wearing device that allows camera zooming for photo capture when there is an object in front of the user within a predetermined distance.

2. The head wearing device in claim #1 is a device with a camera, a mic array, a set of speakers, and a voice assistance system.

3. The head wearing device in claim #2 is a pair of AR glasses.

4. The system in claim #1 uses acoustic characteristics of the user environment to determine the distance of any object in front of the user.

5. The acoustic characteristics in claim #4 are derived based on user voice commands and echos from any object in the user environment.

6. The user voice commands in claim #5 include system wake words for the head wearing device.

7. The predetermined distance in claim #1 is 0.5 meters or another number in the range of 0.25 to 1.0 meters.

8. The camera zooming for photo capture in claim #1 is 2.0× optical zoom relative to a system default setting or another zooming factor in the range of 1.25× to 4.0×.

9. The system in claim #1 provides a user control to enable or disable the camera zooming option.

10. The system in claim #1 allows application integration with a system control to enable or disable the camera zooming option.
